(19) United States
(12) Patent Application Publication
(10) Pub. No.: US 2021/0002919 A1
(43) Pub. Date: Jan. 7, 2021

(54) Convertible Covered Wagon

(71) Applicant: Lucille Camillo, Buffalo, NY (US)

(72) Inventor: Lucille Camillo, Buffalo, NY (US)

(21) Appl. No.: 15/929,671

(22) Filed: May 14, 2020

Related U.S. Application Data
(60) Provisional application No. 62/920,316, filed on Apr. 24, 2019.

(51) Int. Cl. E04H 15/06; B62B 3/00; B62B 3/02; B62B 5/00; B62B 5/06

(52) U.S. Cl. CPC E04H 15/06; B62B 3/002; B62B 2206/006; B62B 5/0013; B62B 5/06; B62B 3/022

(57) ABSTRACT

A covered wagon that converts into an easy set-up platform tent. The wagon comprises a wheel supported wagon bed and an inverted U shaped frame structure. Four side panels are mounted by hinges to the wagon bed and are held in a vertical position by a latch on each of the four joining corners. The inverted U shaped frame structure is mounted to the side panels by hinges and supports the tent enclosure over the wagon bed. Support legs are mounted by hinges on the exterior edge of the four side panels. To convert the covered wagon into a platform tent the corner latches are manually released to allow all four side panels to drop open to a horizontal position and rest on the support legs, the legs simultaneously swing out to a 90 degree angle to support the side panels and create the platform for the platform tent.

Provisional Patent 62/920,316 Apr. 24, 2019

### FIELD OF THE INVENTION

The present invention relates to a convertible covered wagon. More specifically it is a covered wagon that converts into a platform tent.

### BACKGROUND OF THE INVENTION

Regular tents limit the supplies users and the homeless can store and bring with them without the use of a vehicle.

Regular tents are set up on the ground which can be cold, wet, dirty, and uncomfortable.

Regular tents make it difficult for users to keep themselves and their belongings safe. The present invention seeks to provide a solution to these problems by providing a wagon that enables the user to carry supplies in the wagon.

The present invention seeks to provide a solution to these problems by providing a covered wagon that converts into an insulated platform tent.

The present invention seeks to provide a solution to these problems by providing a covered wagon with side panels that are connected to security panels that fold out and can be locked together to form a cage-like enclosure.

### BASIC DESCRIPTION OF THE INVENTION

The covered wagon converts into an insulated platform tent. A thick layer of insulation is installed under the wagon floor bed to insulate the user from the cold.

The tent is secured to six adjustable poles that are connected to the top edge of the two wagon side panels. The three sets of adjustable poles are connected by three flex tubes that form three arches over the wagon bed that support the tent fabric.

The four wagon side panels are connected to the wagon base by removable hinges and the four corners of the wagon are held together by security latches.

Each of the four panels have legs connected to them. When the four corner security latches are released and opened the side panels of the wagon drop down and rest on the legs which creates the platform for the tent.

The wagon has adjustable height poles that enable the user to lower the covered wagon ceiling height or raise the ceiling height when the covered wagon is converted into a platform tent. The two side panels each have additional security panels connected to them that can be locked together to form a cage-like enclosure within the wagon bed. This allows the user to safely lock themselves or their belongings inside of the enclosure.

Preferable the tent would have a front and a back screened door with double zippers.

Preferable there will be two mesh screen windows on both sides of the tent.

Preferably the tent will have an electrical cord portal to allow the user to run electrical cords through an airtight opening.

Preferably the tent will have removable adjustable tent poles that can be raised up for maximum tent ceiling height and also be lowered to minimize the height of the covered wagon. Preferably additional tent fly fabric can be layered over the main tent to provide added protection from rain, wind, and cold.

Preferably the rain fly will have vents for ventilation.

Preferably the covered wagon lead ropes can be secured to utility hooks on the sides of the wagon or to eye hooks on the front and back of the wagon to stabilize the tent structure in windy conditions.

Preferably when converted into a platform tent the lead ropes can be secured to tent stakes that are anchored to the ground or to bags that are weighted with rocks or sand.

Preferably all four panels of the wagon will be secured by corner security latches.

Preferably the wagon can be used as a utility wagon by removing the tent fabric and poles. Preferably the wagon side panels will be connected to the wagon by removable hinges.

Preferably the wagon will have removable hinges on all four side panels to convert the wagon into a flatbed.

Preferably the two wagon side panels will be connected by removable hinges to the security panels to create a cage-like enclosure.

Preferably the security enclosure can be locked either from the outside or from the inside by using a lock.

Preferably both the underside of the floor bed and the sides of the wagon will be insulated.

Preferably the wagon will have either no flat or pneumatic tires.

Preferably the wagon will remain in a stationary position by the use of wheel chocks.

Preferably the wagon will have reflectors or solar powered lights on all four sides of the wagon to allow the wagon to be visible at night.

### BRIEF DESCRIPTION OF DRAWINGS

FIG. 1 is a 3D illustration of the covered wagon with a rainfly cover. From this perspective you can see five of the ten platform support legs.

FIG. 2 this is a front view of the covered wagon as it is converted into a platform tent with wheels as well as support legs.

FIG. 3 is an illustration of the wagon base with the tent fabric removed showing the tent support poles. FIG. 3 also illustrates the wagon side panels ability to move from a vertical upright position to a lowered horizontal position.

FIG. 4 illustrates the adjustable tent pole with a hole on one end and a push button on the other end of the pole that the flex tube slides over to connect two adjustable poles together. FIG. 4 illustrates the parts used to make the hinges that connect the adjustable tent poles and the support legs to the wagon. It illustrates the four screws, two L brackets, the bolt, and the wing nut that are used to make the hinges that connect the six adjustable poles and the ten support legs to the wagon.

FIG. 5 is a 3D perspective of the wagon with the sides down and the tent fabric removed allowing for adjustable poles to be visible.

FIG. 6 is a 3D perspective of a disassembled wagon and its part.

FIG. 7. Illustrates security latch and catch.

FIG. 8 Illustrates removable hair pin hinge

FIG. 9 is a front view of the covered wagon security enclosure.

### DETAILED DESCRIPTION OF THE INVENTION

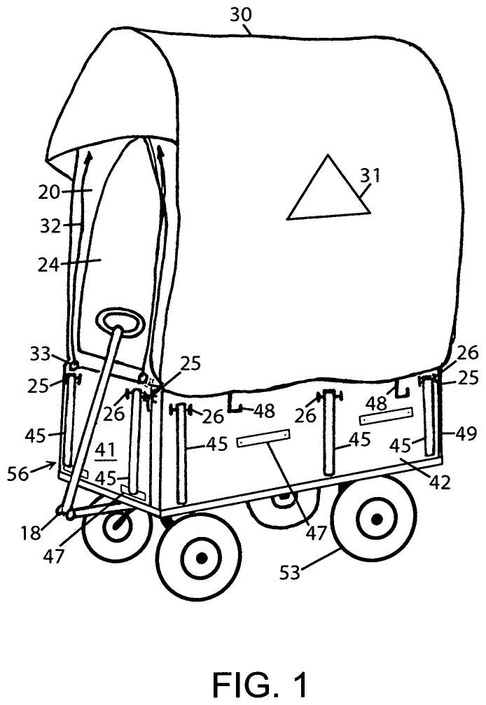

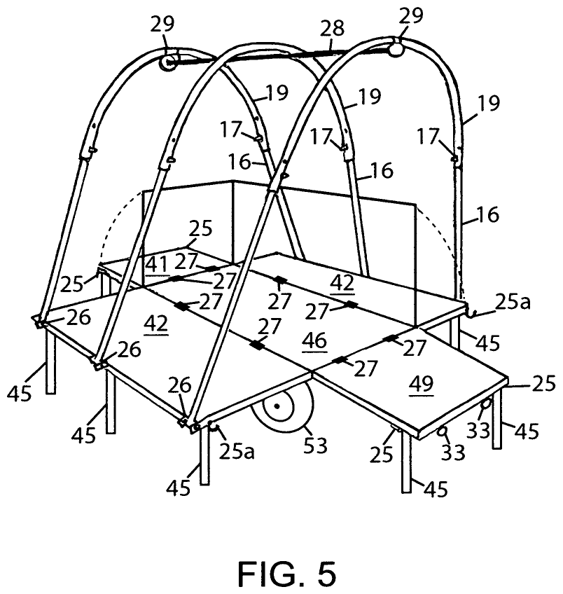

FIG. 1 is a 3D illustration of a four sided covered wagon 56. Connected to the wagon 56 is a water resistant tent 20. The tent 20 fabrics rest on three arches. Three sets of adjustable poles 16 are connected by three flex tubes 19 that form three arches that the tent 20 rests on FIG. 5. The adjustable poles 16 are slipped through small holes at the base of the tent 20 and are secured to the wagon by velcro loops that run along the bottom perimeter of the tent 20. The rain fly 30 lays over the tent 20 to provide an additional layer of weather protection from rain, snow, wind, and cold. The rainfly vents 31 on both sides of the tent 20 can be opened to provide ventilation to the tent windows 21 underneath.

From this perspective you can see five out of the ten support legs 45 connected to the wagon side panel 42 and the front panel 41 by hinges 26. From this angel two out of the four security latches 25 are visible. The security latches 25 and are used to hold the four wagon panels 42, 42, 41, and 49 together in an upright position.

The front screen door 24 and the back screen door 24 are identical in their size and function. Both doors 24 have double zippers 22, one zipper is used to zip open the door panel which allows a breeze to blow through the mesh panel and another zipper is used to open and close the door to the outside.

There are tent leads 32 along the front and back of the tent 20 and are tied to eye hooks 33 that provide stability to the tent structure under windy conditions. The tent leads 32 may also be secured to the utility hooks 48 on the side panels 42. The utility hooks 48 can be used to carry additional bags or to hold fishing poles or any pole type handle such as a broom or shovel. The wagon has reflectors 47 on all four sides of the wagon to allow the wagon to be visible at night.

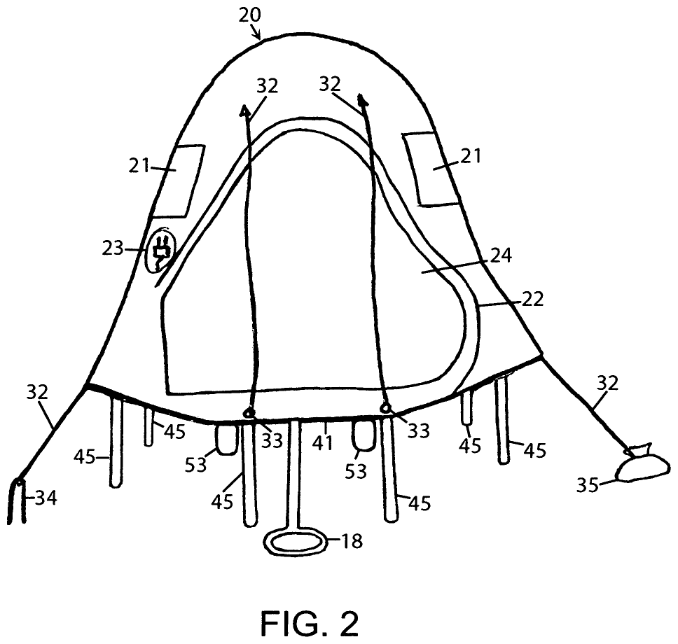

FIG. 2 This is a front view of the wagon as it is converted into a platform tent that is supported by four tires 53 as well as ten support legs 45. With the rainfly 30 removed the two side tent windows 21 are visible. Both tent windows 21 have double zippers one zipper is used to zip open the door panel to allow a breeze to blow through the mesh panel and the other zipper is used to open and close the window to the outside.

On the side of the door there is an electric cord portal 23 that allows the user to run electrical cords through an airtight opening which prevents insects from entering the tent.

To convert the covered wagon into a platform tent the four wagon panels 41, 42, 42, and 49 need to be opened and lowered to rest on the support legs 45. First the security latches 25 must be released from the catches 25a. The security latches 25 are located on the two top corners of the front wagon panel 41 and the two top corners of the back panel 49. The catches 25a are located on the two top corners of the two wagon side panels 42. FIG. 7

To lower the wagon panels 42, 41 and 49 the security latches 25 and catch 25c must be released from both corners of the wagon panel that is to be lowered. Starting from any of the four corners of the wagon the latch 25 is released from the catch 25c, the handle 25b is slid away from the catch 25a which releases the security bolt 25a from the catch 25c. The panels then drop down to rest on the support legs 45 that also drop open with gravity to provide support to the wagon panels 41, 42, 42, and 49 to form the platform for the tent.

Next the user would raise the height of the tent 20 by individually lifting each of the three flex tubes 19 are by pulling in an upward motion until the push button 17 on the adjustable tent pole 16 pops out and is inserted into the hole 19a on both the ends of the flex tube 19. This procedure is repeated three times to raise and secure each of the flex tubes 19 in place. The three flex tubes create three arches that support the tent fabric 20.

To convert the platform tent back into a covered wagon you reverse previous operation. First secure the wagon panels 41, 42, 42, and 49 back into an upright closed position the side wagon panels 42, and either the front panel 41 or back panel 49 are lifted up until the security latch 25 and the catch 25c are aligned, then the security bolt 25a is slid through the security catch 25a and secured in place. Repeat procedure for the other side wagon panel 42 and front panel 41 or back panel 49.

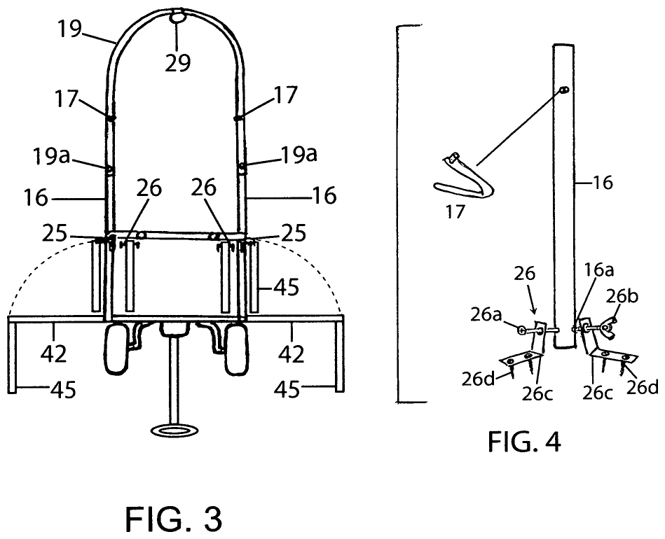

FIG. 3 is a front view of the covered wagon with the tent 20 fabric removed. It shows how one flex tube 19 connects the two adjustable tent poles 16 together that form the arch that the tent 20 rests on. It also illustrates the wagon side panels 42 ability to be moved from a vertical upright position to a lowered horizontal position.

FIG. 4 Illustrates the push button 17, the adjustable tent poles 16, the adjustable tent pole hole 16a, and the hinge.

The adjustable tent poles 16 are connected to the top edge of the wagon side panels 42 by hinges 26. The flex tube 19 connects two adjustable tent poles 16 together to form an arch. Three sets of two adjustable poles 16 and three flex tubes 19 form three arches that the tent 20 rests on. The flex tube 19 has two small holes in a row on both ends of the flex tube 19a. The push button 17 protrudes through a small hole at the top of the adjustable tent pole 16. The flex tube 19 slides over the adjustable tent pole 16 and the push button 17 then protrudes through the flex tube hole 19a and secures the flex tube 19 at a given height.

To use the push button 17 you must press and hold the push button 17 down while sliding the flex tube 19 onto the adjustable tent pole 16 until the push button 17 is inserted into the end of the flex tube 19. With a downward push of the flex tube 19 it slides onto the adjustable pole 16. Then the flex tube hole 19a is aligned with the spring button 17 on the support pole 16 and the push button 17 is released as it inserts into the hole 19a at the base of the flex tube 19.

To lower the covered wagon height the user presses firmly on the spring push button 17 while at the same time holding and forcing the flex tube 19 in a downward motion over the adjustable tent poles 16 until the spring push button 17 engages another flex tube hole 19a farther up the flex tube 19. At which time the spring push button 17 will be inserted into the hole 19a of the flex tube 19 and prevent the flex tube 19 from sliding off of the support pole 16.

FIG. 4 illustrates the four screws 26d, the 2 L brackets 26c, the bolt 26a, and the wing nut 26b that are used to make one hinges 26 that connect the six adjustable poles 16 to the top edge of the wagon side panels 42 and also to connect the ten support legs 45 to the outside surface of the wagon panels 41, 42, 42, and 49 FIG. 3.

The screws 26d are screwed in the top edge of the wagon side panels 42 to secure the hinge to the wagon 56. The bolt 26a is slid through the hole in one L bracket 26c then through the hole on the end of the tent pole 16a then through the hole on the other L bracket 26c and then the wing nut 26a is secured by turning it clockwise over the bolt 26a.

Many different canopy, window, awning, and pole hinges could be used to secure the adjustable tent poles 16 and the support legs 45 to the wagon panels 41, 42, 42, and 49.

FIG. 5 is a 3D perspective of the wagon platform with the tent 20 removed and exposing the six adjustable poles 16, the three connecting flex tubes 19, the top support pole 28, the support pole holders 29, the security panels 44, and the support legs 45. It also shows the four panels 42, 42, 41, 49 in a folded down position and resting on the ten support legs 45.

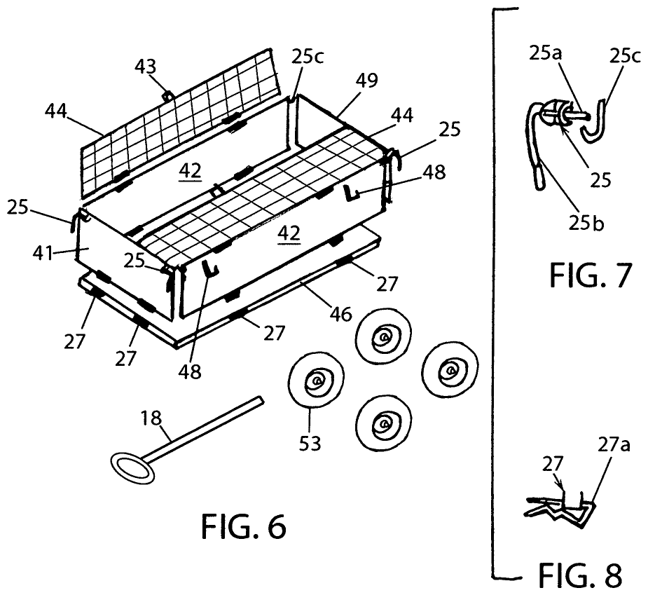

FIG. 6 is a 3D perspective of disassembled wagon parts. It illustrates how the insulated floor bed 21 and the four wagon panels 41, 42, 42, and 49 join together by removable hinges 27. It also shows how the security panel 44 is connected to the two side panels 42 by removable hinges 27. With all four panels 41, 42, 42, and 49.

FIG. 6 shows the handle 18 that is used for pulling the wagon. The handle 18 can be pulled either by hand. FIG. 6. The removable hinge 27 is also used to connect the side panels 42 to the security panels 44. FIG. 6. To separate the panels 41, 42, 42, and 49 from the insulated floor bed 21 the removable hair pin 27a is pulled out of the removable hinge 27. To separate the side panels 42 from the security panels 44 the removable hair pin 27a is pulled out of the removable hinge 27 FIG. 6.

FIG. 6 shows the four tires 53. It shows the four security latches 25 and the catches 25a that join the four wagon panels 41, 42, 42, and 49 together at the corners. FIG. 7. Illustrates security latch 25, the security latch bolt 25a, the security latch handle 25b, and the catch 25c. One security latch is connected to both top corners of the front panel 41 and one security latch is connected to both top corners of the back panel 49. One catch is connected to both top corners of the two side panels 42.

To lower the wagon panels 42, 41 and 49 the security latches 25 and catch 25c must be disengaged from both corners of the wagon panel that is to be lowered. To disengage the latch 25 from the catch 25c the handle 25b is slid away from the catch 25a which releases the security bolt 25a from the catch 25c.

To secure the wagon panels 41, 42, 42, and 49 back into an upright closed position the side wagon panels 42, and either the front panel 41 or back panel 49 are lifted up until the security latch 25 and the catch 25c are aligned then the security bolt 25a is slide through the security catch 25a and secured in place. Repeat procedure for the other side wagon panel 42 and front panel 41.

FIG. 8 Illustrates the removable hinge 27 and removable hair pin 27a that connects the four wagon panels 41, 42, 42, and 49 to the insulated wagon floor bed 46.

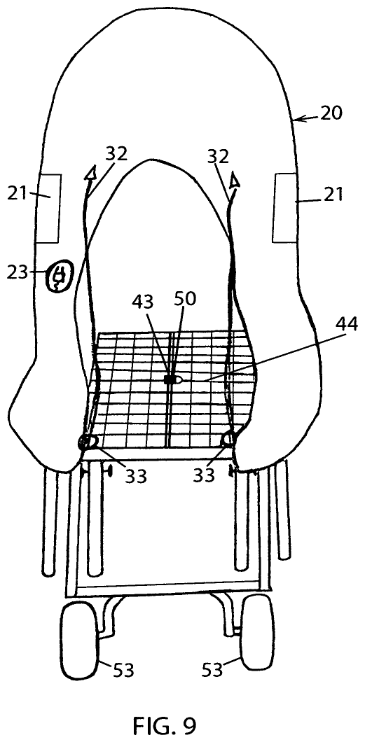

FIG. 9 Is a back view of the covered wagon enclosure. To lock the covered wagon enclosure the user can simply secure a lock 50 through the security cover latch 44b. If the user wishes to secure themselves from the inside of the security panels 44 they can flip the security panels 44 over by first removing the removable hair pin 27a from the removable hinge 27 and then flip the panel over and reinsert the removable hair pin 27a into the removable hinge 27. The user can then lock the security panels 44 from the inside by securing a lock 50 through the security panel latch 44a.

What is claimed is:

1. A covered wagon that converts into an easy set-up platform tent, comprising a base frame, four wheels, a pivoting handle, an inverted U shaped frame structure, and a tent enclosure; four side panels having hinges along the bottom edge whereby they are connected to all four sides of the outer edge of the base frame, all four side panels are held in an upright vertical position by a latch on each of the four connecting corners to define a cargo space, an inverted U shaped frame structure is mounted by hinges to side panels over a base frame, an inverted U shaped frame structure consisting of a minimum of two sets of adjustable poles and are connected together by a minimum of one flex tube each that a tent enclosure is secured to and rests on, a flex tube is a flexible cylindrical tube forced to bow into an inverted U shaped by two connecting rigid adjustable poles that are connected to side panels by hinges, a top horizontal support pole serves to support and stabilize the inverted U shaped frame structure from the wind, the support pole is secured between two support pole holders, the support pole holders are secured to the center of the flex tubes, an adjustable pole is a standard type tent pole with a spring push button protruding near the top end of the pole and the opposite end of the adjustable pole is a hole in which a screw is inserted and fasten to a bracket that is mounted on the top edge of the side panel which creates a hinge, a flex tube has a minimum of two small consecutive holes on both polar ends of the tube to allow for ceiling height adjustment, to transition between the two ceiling heights press and hold the spring push button down while simultaneously sliding the flex tube in a downward or upward motion on the adjustable pole, the spring push button engages the flex tube hole at either the upper hole to form a low ceiling height as is preferred when in a covered wagon state or to the lower hole when a higher ceiling height is preferred in the platform tent state, the adjustable poles are inserted through a minimum of four small openings at the base of the tent enclosure, the tent enclosure encompasses all interior sides keeping the interior dry and protected from the insects as well as the elements, the tent enclosure is secured by a minimum of eight velcro loops on it's interior with four secured at the base of adjustable poles and four secured at the ceiling to the flex tubes, support legs are mounted and hang down from hinges along the top exterior edge of the four side panels, to convert the covered wagon into a platform tent the four corner latches are manually released to allow the four side panels to drop open to a horizontal position and rest on the support legs, the support legs simultaneously swing out to a 90 degree angle in which to support the side panels, the side panels create an extension around the base frame which creates the platform for the platform tent, two elongated lid security panels are approximately the same size as the two elongated vertical side panels, the two elongated lid security panels are connected by hinges to the two elongated side panels to form a six sided rectangular enclosure, the lid security panels may be locked together to secure property, the security panels may be folded down parallel to the vertical side panels to allow for open lid hauling within the covered wagon, no tools are required to transition between the covered wagon state and the platform tent state.

2. The covered wagon of claim 1, wherein the inverted U shaped frame structure could be constructed using three sets of adjustable poles with one flex tube each.

3. A wagon wherein insulated panels may be fastened to all panels to insulate from exterior cold or to maintaintain cold within the insulated area.

4. The covered wagon of claim 1, wherein a hinge with a removable pin may be used in place of all non removable pin hinges for ease of transporting and storage.

5. The covered wagon of claim 1, wherein a vented rain fly secured over the tent enclosure to provide an additional layer of weather protection from rain, snow, wind, and cold.

6. A wagon wherein in reflectors, may be placed on the exterior panels to provide better visibility.

7. The covered wagon of claim 1, wherein the tent enclosure has both a front and back entrance.

9. The covered wagon of claim 1, wherein the tent enclosure has window vents on both sides.
